(19) United States
(12) Patent Application Publication
(10) Pub. No.: US 2026/0239067 A1
(43) Pub. Date: Aug. 13, 2026

(54) MODEL MONITORING USING A PROXY MODEL

(71) Applicant: QUALCOMM INCORPORATED, San Diego, CA (US)

(72) Inventors: Chenxi HAO, Beijing (CN); Jay Kumar SUNDARARAJAN, San Diego, CA (US); Taesang YOO, San Diego, CA (US)

(21) Appl. No.: 19/153,531

(22) PCT Filed: Apr. 7, 2023
(86) PCT No.: PCT/CN2023/086769

§ 371 Date: Aug. 4, 2025

(51) Int. Cl. H04W 24/10; G06F 18/22; H04B 7/06; H04W 24/06

(52) U.S. Cl. CPC H04W 24/10; G06F 18/22; H04B 7/0626; H04W 24/06

(57) ABSTRACT

Various aspects of the present disclosure generally relate to wireless communication. In some aspects, a user equipment (UE) may generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model. The UE may monitor the UE model using the proxy model. The UE may selectively transmit, to a network node, a report associated with monitoring the UE model using the proxy model. Numerous other aspects are described.

### FIELD OF THE DISCLOSURE

Aspects of the present disclosure generally relate to wireless communication and to techniques and apparatuses for model monitoring using a proxy model.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include generating a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model. The method may include monitoring the UE model using the proxy model. The method may include selectively transmitting, to a network node, a report associated with monitoring the UE model using the proxy model.

Some aspects described herein relate to a method of wireless communication performed by a network node. The method may include receiving information associated with a proxy model to be used for monitoring a performance of channel state information feedback. The method may include transmitting, to a UE, configuration information that indicates for the UE to monitor the performance of the channel state information feedback. The method may include selectively receiving, from the UE, a report associated with the UE monitoring the performance of the channel state information feedback.

Some aspects described herein relate to an apparatus for wireless communication at a UE. The apparatus may include a memory and one or more processors coupled to the memory. The one or more processors may be configured to generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model. The one or more processors may be configured to monitor the UE model using the proxy model. The one or more processors may be configured to selectively transmit, to a network node, a report associated with monitoring the UE model using the proxy model.

Some aspects described herein relate to an apparatus for wireless communication at a network node. The apparatus may include a memory and one or more processors coupled to the memory. The one or more processors may be configured to receive information associated with a proxy model to be used for monitoring a performance of channel state information feedback. The one or more processors may be configured to transmit, to a UE, configuration information that indicates for the UE to monitor the performance of the channel state information feedback. The one or more processors may be configured to selectively receive, from the UE, a report associated with the UE monitoring the performance of the channel state information feedback.

Some aspects described herein relate to a non-transitory computer-readable medium that stores a set of instructions for wireless communication by a UE. The set of instructions, when executed by one or more processors of the UE, may cause the UE to generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model. The set of instructions, when executed by one or more processors of the UE, may cause the UE to monitor the UE model using the proxy model. The set of instructions, when executed by one or more processors of the UE, may cause the UE to selectively transmit, to a network node, a report associated with monitoring the UE model using the proxy model.

Some aspects described herein relate to a non-transitory computer-readable medium that stores a set of instructions for wireless communication by a network node. The set of instructions, when executed by one or more processors of the network node, may cause the network node to receive information associated with a proxy model to be used for monitoring a performance of channel state information feedback. The set of instructions, when executed by one or more processors of the network node, may cause the network node to transmit, to a UE, configuration information that indicates for the UE to monitor the performance of the channel state information feedback. The set of instructions, when executed by one or more processors of the network node, may cause the network node to selectively receive, from the UE, a report associated with the UE monitoring the performance of the channel state information feedback.

Some aspects described herein relate to an apparatus for wireless communication. The apparatus may include means for generating a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model. The apparatus may include means for monitoring the UE model using the proxy model. The apparatus may include means for selectively transmitting, to a network node, a report associated with monitoring the UE model using the proxy model.

Some aspects described herein relate to an apparatus for wireless communication. The apparatus may include means for receiving information associated with a proxy model to be used for monitoring a performance of channel state information feedback. The apparatus may include means for transmitting, to a UE, configuration information that indicates for the UE to monitor the performance of the channel state information feedback. The apparatus may include means for selectively receiving, from the UE, a report associated with the UE monitoring the performance of the channel state information feedback.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of models for estimating channel state information, in accordance with the present disclosure.

FIG. 5 is a diagram illustrating an example of model monitoring using a proxy model, in accordance with the present disclosure.

FIG. 6 is a diagram illustrating an example of a proxy model, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

Model training may include joint model training, separate model training, or sequential model training. Joint model training may include a single training entity training a user equipment (UE) model and a network model. Separate model training may include a first training entity training a UE model and a second training entity training an network model. Sequential model training may include a first training entity training a first model (UE or network model) and outputting a training dataset, and a second training entity training a second model (the other of the UE or network model) based at least in part on the training dataset output by the first training entity. For each of the model training options, determining a key performance indicator (KPI) for the model may include calculating a squared generalized cosine similarity (SGCS) between a target CSI (ground truth) and a CSI output by the model. However, this may require the UE to run a network decoder (for the UE to perform the monitoring) or may require the UE to report the ground truth to the network node (for the network node to perform the monitoring). Requiring the UE to run the network decoder and to perform the monitoring may increase UE complexity, while requiring the UE to report the ground truth for the network node to perform the monitoring may increase signaling overhead. Increased UE complexity and signaling overhead may negatively impact CSI enhancement.

Various aspects relate generally to model monitoring. Some aspects more specifically relate to model monitoring using a proxy model. In some aspects, a UE may generate a proxy model to be used for monitoring a UE model (or a UE model and a network model). The proxy model may be configured to receive input that corresponds to an input of the UE model, a latent feature or intermediate result associated with an internal layer or hidden layer of the UE model, and/or an output of the UE model. The proxy model may be configured to generate an output that corresponds to a system performance metric, an intermediate KPI, and/or a prediction of reconstructed CSI obtained by the network node. The proxy model may monitor the UE model (or the UE model and the network model).

Particular aspects of the subject matter described in this disclosure can be implemented to realize one or more of the following advantages. In some examples, by monitoring the UE model (or the UE model and the network model) using the proxy model, the described techniques can be used to improve the accuracy of the UE model (or the UE model and the network model) without increasing UE complexity or signaling overhead.

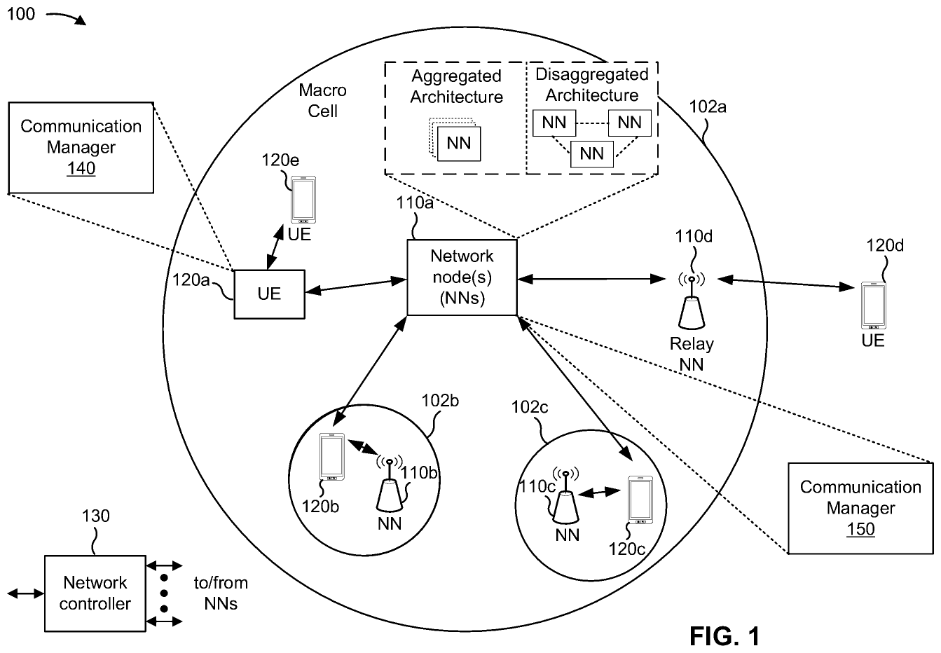

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model; monitor the UE model using the proxy model; and selectively transmit, to a network node, a report associated with monitoring the UE model using the proxy model. Additionally, or alternatively, the communication manager 140 may perform one or more other operations described herein.

In some aspects, the network node 110 may include a communication manager 150. As described in more detail elsewhere herein, the communication manager 150 may receive information associated with a proxy model to be used for monitoring a performance of channel state information feedback; transmit, to a UE, configuration information that indicates for the UE to monitor the performance of the channel state information feedback; and selectively receive, from the UE, a report associated with the UE monitoring the performance of the channel state information feedback. Additionally, or alternatively, the communication manager 150 may perform one or more other operations described herein.

As indicated above, FIG. 1 is provided as an example. Other examples may differ from what is described with regard to FIG. 1.

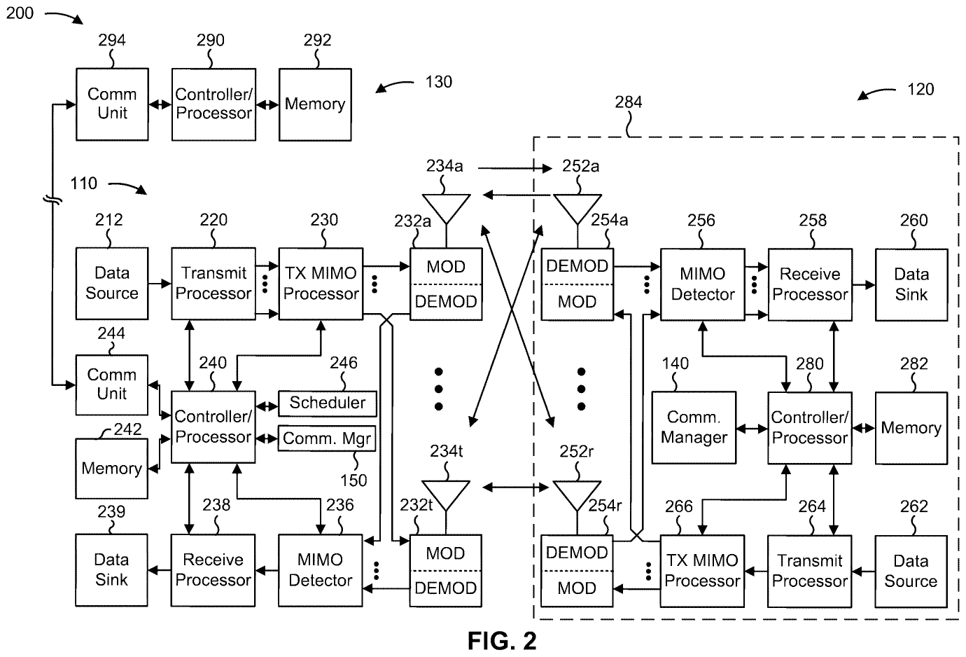

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

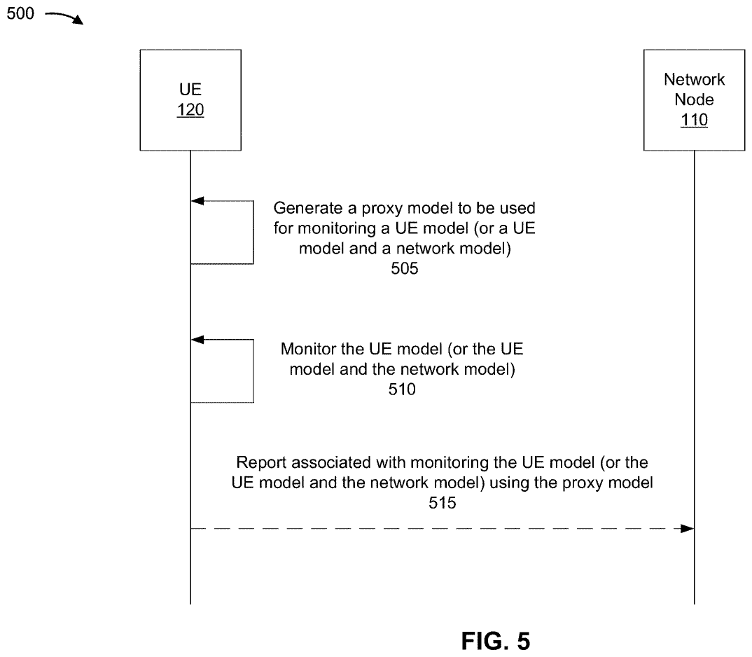

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

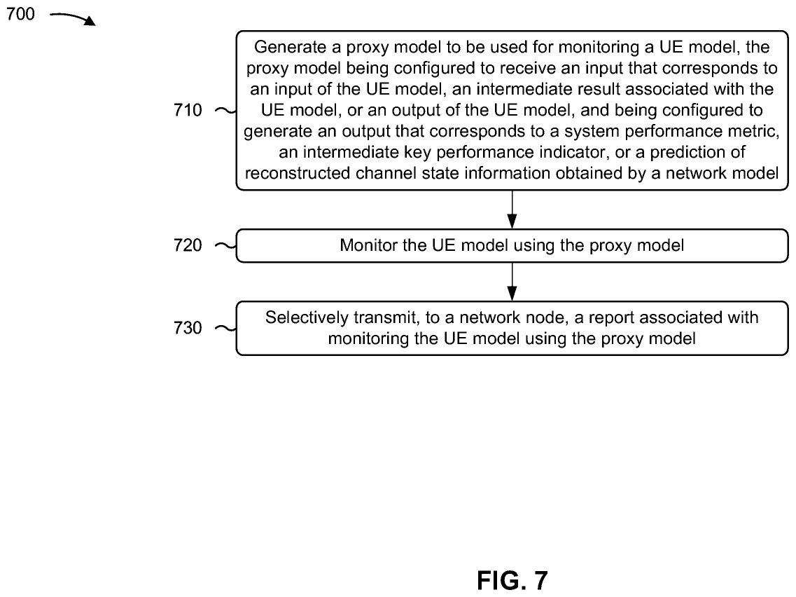

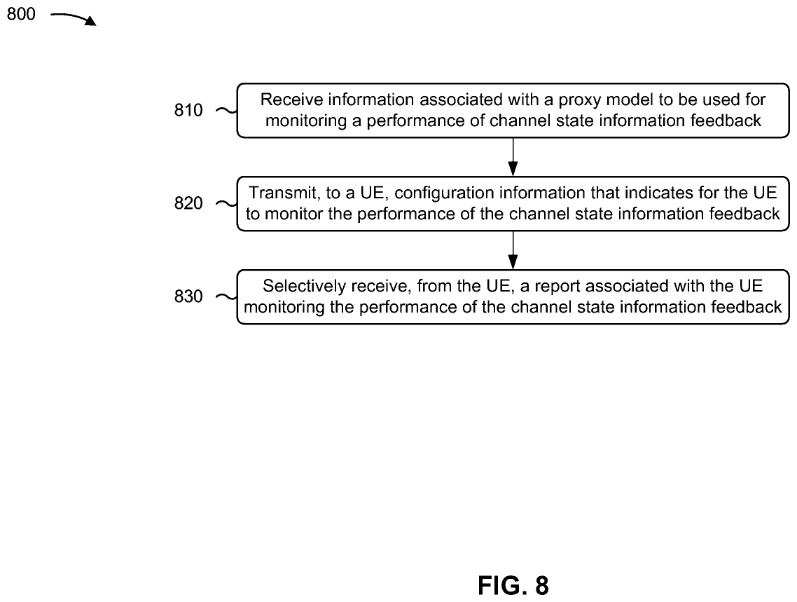

The controller/processor 240 of the network node 110, the controller/processor 280 of the UE 120, and/or any other component(s) of FIG. 2 may perform one or more techniques associated with model monitoring using a proxy model, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for generating a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model; means for monitoring the UE model using the proxy model; and/or means for selectively transmitting, to a network node, a report associated with monitoring the UE model using the proxy model. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving information associated with a proxy model to be used for monitoring a performance of channel state information feedback; means for transmitting, to a UE, configuration information that indicates for the UE to monitor the performance of the channel state information feedback; and/or means for selectively receiving, from the UE, a report associated with the UE monitoring the performance of the channel state information feedback. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

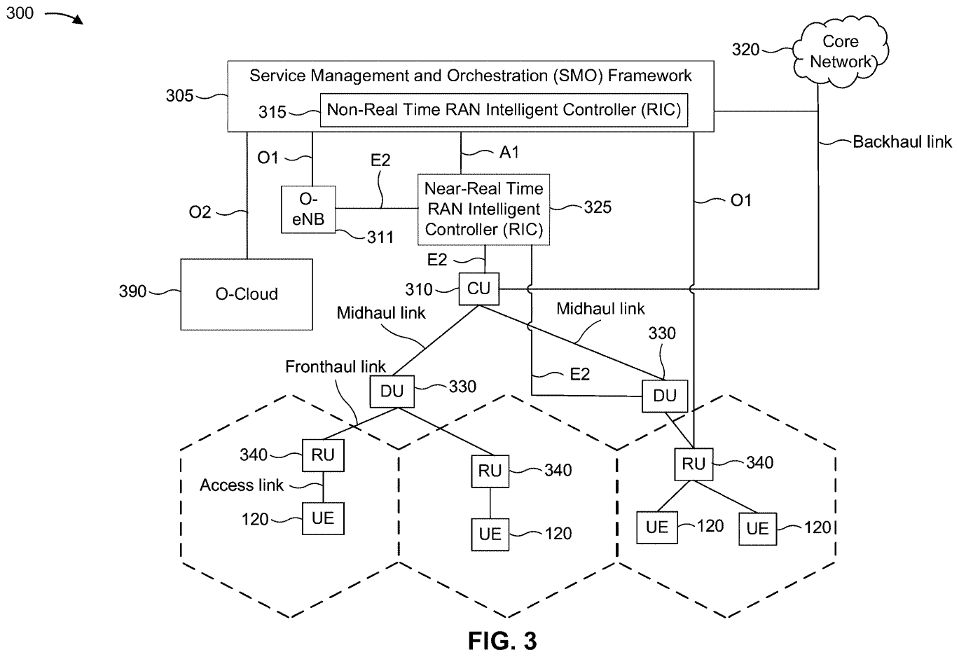

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

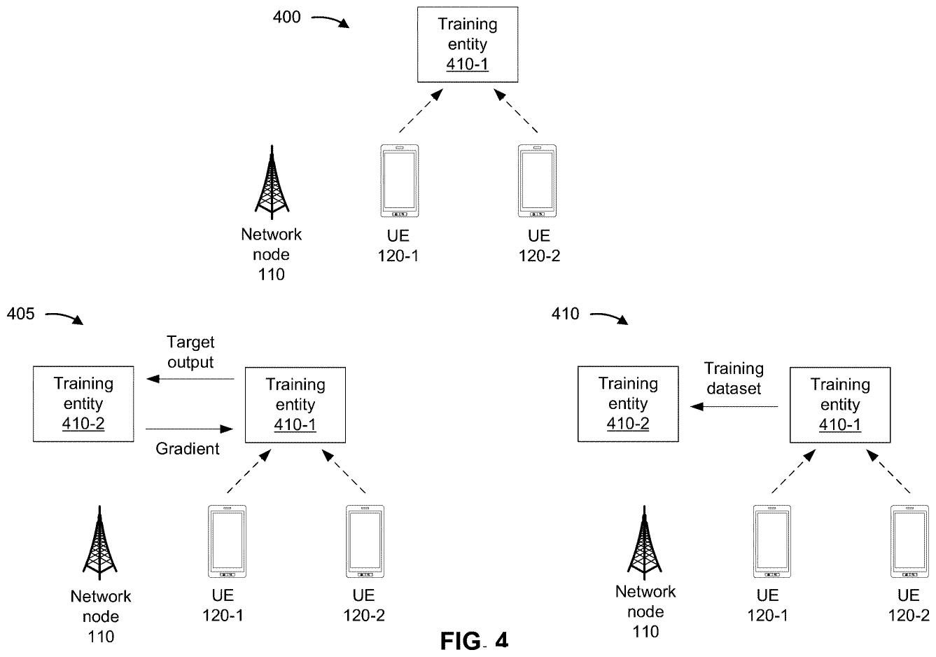

FIG. 4 is a diagram illustrating examples 400, 405, and 410 of models for estimating channel state information, in accordance with the present disclosure.

In some cases, a channel state information (CSI) report configuration may include a codebook. The codebook may be used as a precoding matrix indicator (PMI) dictionary from which a UE may report the best PMI codewords, for example, using a sequence of bits. Artificial intelligence (AI)-based feedback may replace the codebook by using a CSI encoder and decoder. For example, the encoder may be analogous to a PMI searching algorithm and the decoder may be analogous to the PMI codebook which is used to translate the CSI reporting bits into a PMI codeword. In one example, a UE encoder may receive an input, and may output a latent message to a network node. A decoder at the network node may receive the latent message, and may generate an output based at least in part on the latent message. The decoder output may be, for example, a downlink channel matrix (H), a transmit covariance matric, a downlink precoder (V), an interference covariance matrix (Rₙₙ), or a raw or whitened downlink channel, among other examples. In one example, the encoder input may be H, and the decoder output may be H or V or SV. In another example, the encoder input may be V, and the decoder output may be V. In another example, the encoder input may be Ran, and the decoder output may be Rₙₙ.

In some cases, as shown in the example 400, joint model training may be performed for a UE model and a network model. A training entity 410-1 may handle training for one or more UE models (UE-side models) and one or more network models (network-side models). After model training, the models may be transferred to the UE 120 (e.g., UE 120-1 and/or UE 120-2) and/or the network node 110. Training data may be collected and/or uploaded to the training entity 410-1 in accordance with a priority.

As shown in the example 405, separate model training may be performed for the UE 120 and the network node 110. A training entity 410-1 associated with the UE 120 may send a target output (e.g., a ground truth) to a training entity 410-2 associated with the network node before training starts. In a training phase, the training entity 410-1 may send activation to the training entity 410-2. The training entity 410-2 may send a gradient to the training entity 410-1 for back-propagation.

As shown in the example 410, sequential model training may be performed for the UE 120 and the network node 110. In a UE-first training, the UE 120 may upload data to the training entity 410-1 associated with the UE. The training entity 410-1 may first train the UE side model (i.e., the encoder) and a decoder (such as a private decoder or a reference decoder). Subsequently, the training entity 410-1 may share a latent message output by the UE model and the target output (e.g., the ground truth) (ν), or may share an output by the reference decoder (νhat_ue) to the training entity 410-2 associated with the network. The training entity 410-2 may train a network model using z as an input and ν or νhat_ue as the target output. In network-first training, the training entity 410-1 may share the data and the target output to the second training entity 410-2. The second training entity 410-2 may train the network model, for example, with an encoder (such as a private encoder or a reference encoder). The second training entity 410-2 may send the input of the encoder (ν) and a latent message output by the encoder (z) to the training entity 410-1. The training entity 410-1 may train the UE model using ν as an input and z as an output.

In some cases, model monitoring may be used to identify or reduce improper training or validation datasets, such as datasets not containing sufficiently diverse scenarios, variations, and UE locations, among other examples, that may be encountered as a result of interference. In some cases, model monitoring may be used to identify or reduce improper model design or training, for example, as a result of a model design not being sufficient or a training loss being unacceptably high. In some cases, model monitoring may be used to identify or reduce imperfect model selection and switching, for example, as a result of the UE using a wrong model. In some cases, model monitoring may be used to identify or reduce a likelihood of a target platform being different than a training platform, for example, when a model is trained at a network server and is transferred to a UE. In some cases, model monitoring may be used to identify or reduce a data distribution shift that occurs in slow time scale, such as an appearance of a new building on a site. In some cases, model monitoring may be used to identify or reduce unexpected events. For example, proper dataset construction may minimize unexpected events so that a training dataset has a wide coverage of operating conditions (e.g., UE locations, speeds, signal-to-noise ratios, blocking, or timing errors, among other examples), but may not eliminate all unexpected events. In some cases, KPI monitoring may be able to identify issues, report the issues to the network, and initiate re-training to improve model performance.

As described herein, model training may include joint model training, separate model training, or sequential model training. Joint model training may include a single training entity training a UE model and a network model. Separate model training may include a first training entity training a UE model and a second training entity training a network model. Sequential model training may include a first training entity training a first model (UE or network model) and generating a training dataset, and a second training entity training a second model (the other of the UE or network model) based at least in part on the training dataset output by the first training entity. For each of the model training options, determining the KPI may include calculating an SGCS between a target CSI (ground truth) and a CSI output by the model (for example, to determine the accuracy of the CSI compression and decompression). The SGCS may be calculated as follows:

$$SGCS : \frac{{\vert {x}^{H} \cdot y \vert}^{2}}{{‖ x ‖}^{2} \cdot {‖ y ‖}^{2}} ,$$

$$where x and y are Nx 1 vectors and {x}^{H} is the conjugate transpose of x .$$

However, this may require the UE to run the network decoder (for the UE to perform the monitoring) or may require the UE to report the ground truth to the network node (for the network node to perform the monitoring). Requiring the UE to run the network decoder and to perform the monitoring may increase UE complexity, while requiring the UE to report the ground truth for the network node to perform the monitoring may increase signaling overhead. Increased UE complexity and payload size may negatively impact CSI enhancement.

Techniques and apparatuses are described herein for model monitoring using a proxy model. In some aspects, a UE may generate a proxy model to be used for monitoring a UE model (or a UE model and a network model). The proxy model may be configured to receive input that corresponds to an input of the UE model, a latent feature output by the UE model, and/or an output of the UE model. The proxy model may be configured to generate an output that corresponds to a system performance metric, an intermediate KPI, and/or a prediction of reconstructed CSI obtained by the network node. The proxy model may monitor the UE model (or the UE model and the network model).

Particular aspects of the subject matter described in this disclosure can be implemented to realize one or more of the following advantages. In some examples, by monitoring the UE model (or the UE model and the network model) using the proxy model, the described techniques can be used to improve the accuracy of the UE model (or the UE model and the network model) without increasing UE complexity or signaling overhead.

As indicated above, FIG. 4 is provided as an example. Other examples may differ from what is described with regard to FIG. 4.

FIG. 5 is a diagram illustrating an example 500 of model monitoring using a proxy model, in accordance with the present disclosure.

As shown by reference number 505, the UE 120 or first training entity 410-1 may generate a proxy model. Generating the proxy model may include one or more of creating the proxy model, developing the proxy model, or training the proxy model, among other examples. The proxy model may be used for monitoring a UE model. Alternatively, the proxy model may be used for monitoring the UE model and a network model. The proxy model may be configured to receive an input. The input may correspond to an input to the UE model. The input may correspond to a latent feature output by the UE model, such as a latent feature output by a hidden layer associated with (e.g., inside) the UE model. The input may correspond to an output of the UE model. The proxy model may be configured to generate an output. The output may correspond to a system performance metric, such as a block error rate (BLER), a spectral efficiency, or throughput, among other examples. The output may correspond to an intermediate KPI, such as an SGCS between a ground truth of the CSI feedback (ν_ideal or ν where ν_ideal is the CSI based on ideal downlink channel estimation and ν is the CSI based on the realistic downlink channel estimation) and reconstructed CSI obtained by the network model (νhat). The output may correspond to a prediction of the reconstructed CSI obtained by the network model, and the UE 120 or first training entity 410-1 may calculate the intermediate KPI using the ground truth of the CSI feedback and the predicted reconstructed CSI. The UE 120 or first training entity 410-1 may generate one proxy model per two-sided model (e.g., using a one-to-one mapping between a proxy model and a model identifier (ID) used for inference) or may generate one proxy model to be used for all models under the configured functionality.

In some aspects, the proxy model may be configured to monitor only the UE model. For example, the proxy model may be configured to monitor a single model that corresponds to the UE model. For UE model monitoring, the proxy model may be developed based at least in part on a decoder (such as a private decoder or a reference decoder) that mimics the network model. In a first operation, the first training entity 410-1 may develop the decoder, and the decoder may be configured to output a reconstructed CSI. For UE-first sequential training, the first training entity 410-1 may develop the UE model and the decoder using collected data. For network-first sequential training, the network node 110 or second training entity 410-2 may develop the network model and a reference encoder using data collected and transferred from the UE 120 or UE side training entity 410-1. The network node 110 or second training entity 410-2 may provide the input of the reference encoder (V or H) and the output of the reference encoder (z) to the UE 120. The first training entity 410-1 may develop the UE model using V, H, and/or z. The UE model may receive V and H as an input and may generate an output (zhat) which is an estimate of z. The first training entity 410-1 may develop the reference/private decoder taking zhat as an input and V as the target output. In a second operation, an SGCS may be calculated between the ground truth CSI (ν or ν_ideal) and the reconstructed CSI output by the UE reference/private decoder for all samples in a training set. In a third operation, the first training entity 410-1 may develop the proxy model using the SGCS. In some aspects, the UE reference/private decoder is designed powerful enough so that the performance monitoring is mainly for the UE model.

In some aspects, the proxy model may be configured to monitor the UE model and the network model. The proxy model may be developed based at least in part on an output of the network model, a KPI of the network model, or decoder information. In the example that the proxy model is based at least in part on the output of the network model (νhat), the training entity 410-1 may be configured to calculate an SGCS value for each training sample by comparing νhat with the target CSI V. The training entity 410-1 may train the proxy model using the one or more SGCS values. For UE-first sequential training, the training entity 410-1 may train the UE model using V or Has an input and z as an output, and may train a private decoder using z as an input and νhat_ue as an output. The training entity 410-1 may provide z and νhat_ue (or the target CSI V) to the training entity 410-2. The training entity 410-2 may train the network model using z as the input and νhat as the output. Subsequently, the training entity 410-2 may provide νhat to the training entity 410-1, which may be used to calculate SGCS label for training the proxy model. For network-first sequential training, the network node 110 or second training entity 410-2 may develop a network model and a reference encoder. The network node 110 may provide the input of the reference encoder (V or H), the output of the reference encoder (z), and the reconstructed CSI (νhat) to the UE 120 or first training entity 410-1. The UE 120 or first training entity 410-1 may develop the UE model using the input of the reference encoder (V or H) and the output of the reference encoder (z). The reconstructed CSI (νhat) is then used to calculate SGCS label so as to train the proxy model. In the example that the proxy model is based at least in part on the KPI generated by the output of the network model (e.g., the SGCS value), the training entity 410-1 may train the proxy model using one or more SGCS values. The training entity 410-1 may obtain the SGCS values from the training entity 410-2. For example, for UE first training, after network completes training the network side model, the training entity 410-1 may receive the SGCS values from the training entity 410-2 with the reconstructed CSI (νhat). Alternatively, for network-first training, after the network side completes training the network side model, the training entity 410-1 may receive the SGCS values from the training entity 410-2 with the input of the reference encoder (V or H), the output of the reference encoder (z), and the reconstructed CSI (νhat). In the example that the proxy model is based at least in part on the decoder information, the decoder information may be a decoder backbone structure, a decoder depth, or a decoder dimension, among other examples. The UE 120 may or first training entity 410-1 design the decoder based at least in part on the decoder information. The output of the network model, the KPI, and/or the decoder information may be updated by the network node periodically, such as in accordance with an interval. Additionally, or alternatively, the output of the network model, the KPI, and/or the decoder information may be updated by the network node based at least in part on an update to the network model. The update may occur periodically, semi-persistently or aperiodically.

In some aspects, the UE 120 or first training entity 410-1 may generate a proxy model for each UE model. The UE 120 may feed an input or latent of a UE model k to an associated proxy model k, resulting in SGCS_k. The UE 120 may compare the SGCS_k obtained by all of the models, and may switch to a model with the highest SGCS_k value. For example, the UE 120 or first training entity 410-1 may generate a first proxy model associated with a first UE model and may generate a second proxy model associated with a second UE model. The UE 120 or first training entity 410-1 may feed an input or latent of the first UE model to the first proxy model to generate a first SGCS, and may feed an input or latent of the second UE model to the second proxy model to generate a second SGCS. The UE 120 or first training entity 410-1 may compare the first SGCS and the second SGCS. The UE 120 or first training entity 410-1 may switch from the first UE model to the second UE model based at least in part on the second SGCS being greater than the first SGCS, or may switch from the second UE model to the first UE model based at least in part on the first SGCS being greater than the second SGCS. In one example, the UE 120 or first training entity 410-1 may always switch to the UE model associated with the highest SGCS value. In another example, the UE 120 or first training entity 410-1 may only switch to the UE model associated with the highest SGCS value based at least in part on an SGCS value of a current UE model not being associated with the highest SGCS value and not satisfying an SGCS threshold.

In some aspects, the UE 120 or first training entity 410-1 may generate a global proxy model across all UE models. The UE 120 or first training entity 410-1 may feed an input or latent of a UE model k to the global proxy model, resulting in SGCS_k. The UE 120 or first training entity 410-1 may compare the SGCS_k obtained by all of the models, and may switch to a model with the highest SGCS_k value. For example, the UE 120 or first training entity 410-1 may feed an input or latent of a first UE model to the global proxy model to generate a first SGCS, and may feed an input or latent of the second UE model to the global proxy model to generate a second SGCS. The UE 120 or first training entity 410-1 may compare the first SGCS and the second SGCS. The UE 120 or first training entity 410-1 may switch from the first UE model to the second UE model based at least in part on the second SGCS being greater than the first SGCS, or may switch from the second UE model to the first UE model based at least in part on the first SGCS being greater than the second SGCS. In one example, the UE 120 or first training entity 410-1 may always switch to the UE model associated with the highest SGCS value. In another example, the UE 120 or first training entity 410-1 may only switch to the UE model associated with the highest SGCS value based at least in part on an SGCS value of a current UE model not being associated with the highest SGCS value and not satisfying an SGCS threshold.

As shown by reference number 510, the UE 120 or first training entity 410-1 may monitor the UE model (or the UE model and the network model) using the proxy model. For example, the UE 120 or first training entity 410-1 may monitor only the UE model using the proxy model. In another example, the UE 120 or first training entity 410-1 may monitor the UE model and the network model using the proxy model.

As shown by reference number 515, the UE 120 may transmit, and the network node 110 may receive, a report associated with monitoring the UE model (or the UE model and the network model) using the proxy model. The report may include an indication of the SGCS value. In some aspects, the UE 120 may transmit the report to the network node 110 based at least in part on a predicted SGCS value not satisfying (e.g., being less than) an SGCS threshold. The report may include one or more measurement instances associated with the SGCS value not satisfying the SGCS threshold and/or statistics associated with the SGCS value not satisfying the SGCS threshold. The SGCS threshold may be configured by the network node 110 and/or may be determined during model development. In one example, the UE 120 may transmit the report based at least in part on an average SGCS over a monitoring window (e.g., a time period) not satisfying an average SGCS threshold. The length of the monitoring window may be predetermined or may be configured by the network node 110. In another example, the UE 120 may transmit the report based at least in part on a number of SGCS values that are less than the SGCS threshold within the monitoring window being less than a second threshold. The second threshold and the length of the monitoring window may be predetermined or may be configured by the network node 110. In some aspects, the UE 120 may wait a time period between sending reports. For example, if the report is sent to the network node 110, the UE 120 may not send another report to the network node 110 until an expiration of a timer. In one example, if the UE 120 sends a report in slot n, the UE 120 may not send another report for another 50 milliseconds (until slot n+50).

As indicated above, FIG. 5 is provided as an example. Other examples may differ from what is described with regard to FIG. 5.

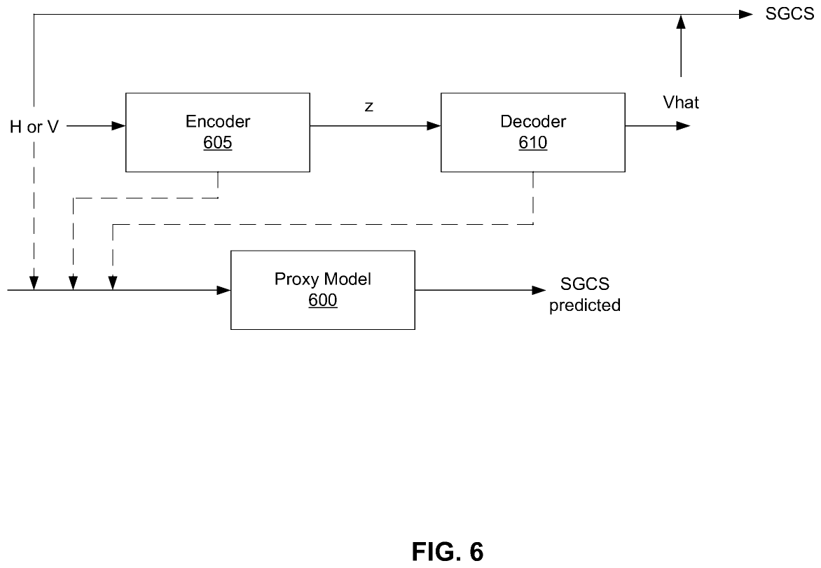

FIG. 6 is a diagram illustrating an example of a proxy model 600, in accordance with the present disclosure. The proxy model 600 may be used for monitoring a UE model. The UE model may include an encoder 605 and a decoder 610. The encoder 605 may receive an input (H or V) and may generate an output z. The decoder 610 may receive z as an input and may generate an output νhat. The UE model may output an SGCS value that is based at least in part on the encoder input (H or V) and the decoder output (νhat). The proxy model 600 may receive the encoder input (H or V), the encoder output (z), and the decoder output (νhat). The proxy model 600 may output an SGCS predicted value. The SGCS predicted value that is output by the proxy model 600 may be compared to the SGCS value output by the UE model to monitor the performance of the UE model.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with model monitoring using a proxy model.

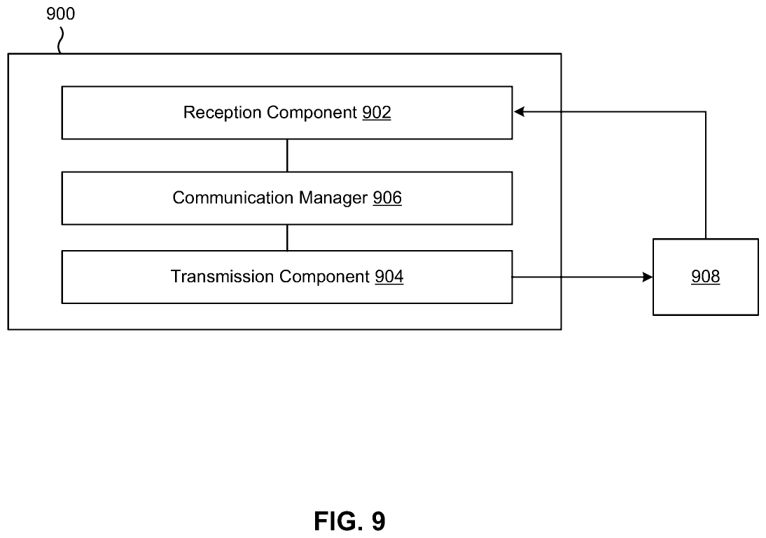

As shown in FIG. 7, in some aspects, process 700 may include generating a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model (block 710). For example, the UE (e.g., using communication manager 906, depicted in FIG. 9) may generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model, as described above.

As further shown in FIG. 7, in some aspects, process 700 may include monitoring the UE model using the proxy model (block 720). For example, the UE (e.g., using communication manager 906, depicted in FIG. 9) may monitor the UE model using the proxy model, as described above.

As further shown in FIG. 7, in some aspects, process 700 may include selectively transmitting, to a network node, a report associated with monitoring the UE model using the proxy model (block 730). For example, the UE (e.g., using transmission component 904 and/or communication manager 906, depicted in FIG. 9) may selectively transmit, to a network node, a report associated with monitoring the UE model using the proxy model, as described above.

Process 700 may include additional aspects, such as any single aspect or any combination of aspects described below and/or in connection with one or more other processes described elsewhere herein.

In a first aspect, the proxy model is to be used for monitoring a single model that corresponds to the UE model.

In a second aspect, alone or in combination with the first aspect, generating the proxy model comprises generating the proxy model based at least in part on a UE decoder that is configured to mimic the network model, wherein the UE decoder is a private decoder or a reference decoder.

In a third aspect, alone or in combination with one or more of the first and second aspects, process 700 includes generating the UE decoder, wherein the UE decoder is further configured to output the reconstructed channel state information, and calculating a squared generalized cosine similarity between target channel state information and the reconstructed channel state information for each sample in a training set associated with the proxy model, wherein generating the proxy model comprises generating the proxy model based at least in part on the squared generalized cosine similarity.

In a fourth aspect, alone or in combination with one or more of the first through third aspects, the proxy model is associated with UE-first sequential training, and wherein the UE model and the UE decoder are generated using data that is collected by a downlink measurement.

In a fifth aspect, alone or in combination with one or more of the first through fourth aspects, the proxy model is associated with network-first sequential training, and wherein the method further comprises receiving an input of a reference encoder associated with the network model and an output of the reference encoder associated with the network model, and generating the UE model based at least in part on an input that corresponds to the input of the reference encoder and an output that corresponds to an estimate of the output of the reference encoder, wherein the UE decoder is configured to receive the output of the UE model as an input and to generate an output that is based at least in part on the input of the reference encoder or a target downlink precoder associated with a downlink measurement in a data collection.

In a sixth aspect, alone or in combination with one or more of the first through fifth aspects, the proxy model is to be used for monitoring a plurality of models that includes the UE model and the network model.

In a seventh aspect, alone or in combination with one or more of the first through sixth aspects, generating the proxy model comprises generating the proxy model based at least in part on the reconstructed channel state information.

In an eighth aspect, alone or in combination with one or more of the first through seventh aspects, process 700 includes calculating a squared generalized cosine similarity, for each training sample associated with the proxy model, based at least in part on comparing the reconstructed channel state information with target or ground-truth channel state information.

In a ninth aspect, alone or in combination with one or more of the first through eighth aspects, the proxy model is associated with UE-first sequential training, and wherein the method further comprises training the UE model using an input that corresponds to an input of an encoder and an output that corresponds to an output of the encoder, and a decoder having an input that corresponds to an output of the encoder and an output that corresponds to a UE estimation of channel state information, providing the output of the encoder and the UE estimation of channel state information to the network node, and receiving the reconstructed channel state information from the network node.

In a tenth aspect, alone or in combination with one or more of the first through ninth aspects, the proxy model is associated with network-first sequential training, and wherein the method further comprises receiving, from the network node, an input of a reference encoder, an output of a reference encoder, and the reconstructed channel state information, and generating the UE model based at least in part on the input of the reference encoder and the output of the reference encoder.

In an eleventh aspect, alone or in combination with one or more of the first through tenth aspects, generating the proxy model comprises generating the proxy model based at least in part on a key performance indicator associated with the network model.

In a twelfth aspect, alone or in combination with one or more of the first through eleventh aspects, process 700 includes obtaining a squared generalized cosine similarity based at least in part on an output of the network model or based at least in part on an input of a reference encoder, an output of a reference encoder, and the reconstructed channel state information.

In a thirteenth aspect, alone or in combination with one or more of the first through twelfth aspects, generating the proxy model comprises generating the proxy model based at least in part on decoder information.

In a fourteenth aspect, alone or in combination with one or more of the first through thirteenth aspects, process 700 includes updating an output of the network model, a key performance indicator of the network model, or decoder information based at least in part on an interval or based at least in part on an update associated with the network model.

In a fifteenth aspect, alone or in combination with one or more of the first through fourteenth aspects, selectively transmitting the report to the network node comprises transmitting the report to the network node based at least in part on one or more SGCS values not satisfying an SGCS threshold.

In a sixteenth aspect, alone or in combination with one or more of the first through fifteenth aspects, the report indicates one or more measurement instances associated with the one or more SGCS values not satisfying the SGCS threshold.

In a seventeenth aspect, alone or in combination with one or more of the first through sixteenth aspects, transmitting the report to the network node based at least in part on the one or more SGCS values not satisfying the SGCS threshold comprises transmitting the report to the network node based at least in part on an average SGCS value not satisfying an average SGCS threshold within a monitoring window.

In an eighteenth aspect, alone or in combination with one or more of the first through seventeenth aspects, transmitting the report to the network node based at least in part on the one or more SGCS values not satisfying the SGCS threshold comprises transmitting the report to the network node based at least in part on a number of SGCS values that do not satisfy the SGCS threshold within a monitoring window satisfying another threshold.

In a nineteenth aspect, alone or in combination with one or more of the first through eighteenth aspects, process 700 includes refraining from transmitting another report to the network node until an expiration of a timer.

In a twentieth aspect, alone or in combination with one or more of the first through nineteenth aspects, generating the proxy model comprises generating a plurality of proxy models associated with a respective plurality of UE models.

In a twenty-first aspect, alone or in combination with one or more of the first through twentieth aspects, process 700 includes generating a first SGCS based at least in part on feeding a first input or latent of a first UE model of the plurality of UE models to a corresponding first proxy model of the plurality of proxy models, generating a second SGCS based at least in part on feeding a second input or latent of a second UE model of the plurality of UE models to a corresponding second proxy model of the plurality of proxy models, and comparing the first SGCS and the second SGCS.

In a twenty-second aspect, alone or in combination with one or more of the first through twenty-first aspects, process 700 includes switching from the first UE model to the second UE model based at least in part on the second SGCS being greater than the first SGCS.

In a twenty-third aspect, alone or in combination with one or more of the first through twenty-second aspects, process 700 includes switching from the first UE model to the second UE model based at least in part on the first SGCS being lower than an SGCS threshold and based at least in part on the second SGCS being greater than the first SGCS.

In a twenty-fourth aspect, alone or in combination with one or more of the first through twenty-third aspects, generating the proxy model comprises generating a global proxy model across all UE models of a plurality of UE models associated with a network model identifier.

In a twenty-fifth aspect, alone or in combination with one or more of the first through twenty-fourth aspects, process 700 includes generating a first SGCS based at least in part on feeding a first input or latent of a first UE model of the plurality of UE models to the global proxy model, generating a second SGCS based at least in part on feeding a second input or latent of a second UE model of the plurality of UE models to the global proxy model, and comparing the first SGCS and the second SGCS.

In a twenty-sixth aspect, alone or in combination with one or more of the first through twenty-fifth aspects, process 700 includes switching from the first UE model to the second UE model based at least in part on the second SGCS being greater than the first SGCS.

In a twenty-seventh aspect, alone or in combination with one or more of the first through twenty-sixth aspects, process 700 includes switching from the first UE model to the second UE model based at least in part on the first SGCS being lower than an SGCS threshold and based at least in part on the second SGCS being greater than the first SGCS.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with model monitoring using a proxy model.

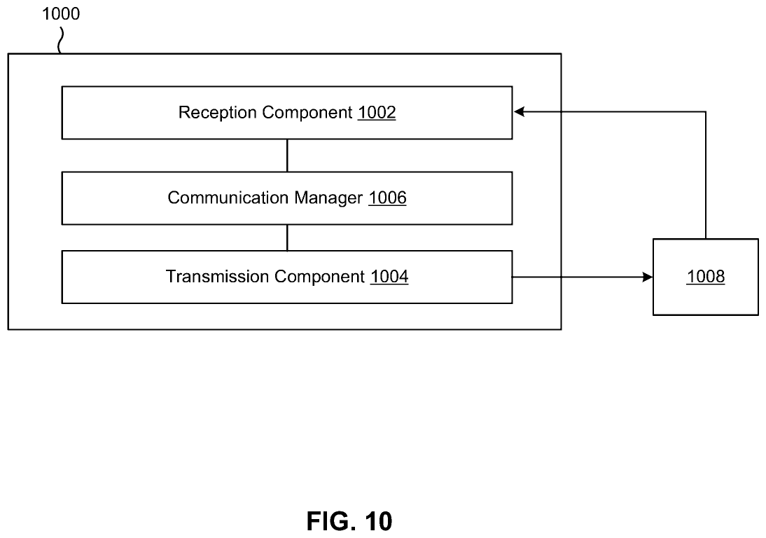

As shown in FIG. 8, in some aspects, process 800 may include receiving information associated with a proxy model to be used for monitoring a performance of channel state information feedback (block 810). For example, the network node (e.g., using reception component 1002 and/or communication manager 1006, depicted in FIG. 10) may receive information associated with a proxy model to be used for monitoring a performance of channel state information feedback, as described above.

As further shown in FIG. 8, in some aspects, process 800 may include transmitting, to a UE, configuration information that indicates for the UE to monitor the performance of the channel state information feedback (block 820). For example, the network node (e.g., using communication manager 1006, depicted in FIG. 10) may transmit, to the UE, configuration information that indicates for the UE to monitor the performance of the channel state information feedback, as described above.

As further shown in FIG. 8, in some aspects, process 800 may include selectively receiving, from the UE, a report associated with the UE monitoring the performance of the channel state information feedback (block 830). For example, the network node (e.g., using transmission component 1004 and/or communication manager 1006, depicted in FIG. 10) may selectively receive, from the UE, a report associated with the UE monitoring the performance of the channel state information feedback, as described above.

Process 800 may include additional aspects, such as any single aspect or any combination of aspects described below and/or in connection with one or more other processes described elsewhere herein.

In a first aspect, the configuration information indicates for the UE to monitor the performance of the channel state information feedback based at least in part on monitoring a UE model or based at least in part on monitoring a UE model and a network model.

In a second aspect, alone or in combination with the first aspect, process 800 includes transmitting, to the UE, information to assist the UE with developing the proxy model. In a third aspect, alone or in combination with one or more of the first and second aspects, the information to assist the UE with developing the proxy model includes reconstructed channel state information, a squared generalized cosine similarity value, or decoder information.

In a fourth aspect, alone or in combination with one or more of the first through third aspects, the configuration information includes an indication of a pairing identifier associated with a two-sided channel state information feedback model to be monitored by the UE, or includes an explicit indication of proxy monitoring information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model. The communication manager 906 may monitor the UE model using the proxy model. The transmission component 904 may selectively transmit, to a network node, a report associated with monitoring the UE model using the proxy model.

The communication manager 906 may generate the UE decoder, wherein the UE decoder is further configured to output the reconstructed channel state information. The communication manager 906 may calculate a squared generalized cosine similarity between target channel state information and the reconstructed channel state information for each sample in a training set associated with the proxy model wherein generating the proxy model comprises generating the proxy model based at least in part on the squared generalized cosine similarity. The communication manager 906 may calculate a squared generalized cosine similarity, for each training sample associated with the proxy model, based at least in part on comparing the reconstructed channel state information with target or ground-truth channel state information. The reception component 902 may obtain a squared generalized cosine similarity based at least in part on an output of the network model or based at least in part on an input of a reference encoder, an output of a reference encoder, and the reconstructed channel state information. The communication manager 906 may update an output of the network model, a key performance indicator of the network model, or decoder information based at least in part on an interval or based at least in part on an update associated with the network model. The communication manager 906 may refrain from transmitting another report to the network node until an expiration of a timer.

The communication manager 906 may generate a first SGCS based at least in part on feeding a first input or latent of a first UE model of the plurality of UE models to a corresponding first proxy model of the plurality of proxy models. The communication manager 906 may generate a second SGCS based at least in part on feeding a second input or latent of a second UE model of the plurality of UE models to a corresponding second proxy model of the plurality of proxy models. The communication manager 906 may compare the first SGCS and the second SGCS. The communication manager 906 may switch from the first UE model to the second UE model based at least in part on the second SGCS being greater than the first SGCS. The communication manager 906 may switch from the first UE model to the second UE model based at least in part on the first SGCS being lower than an SGCS threshold and based at least in part on the second SGCS being greater than the first SGCS. The communication manager 906 may generate a first SGCS based at least in part on feeding a first input or latent of a first UE model of the plurality of UE models to the global proxy model. The communication manager 906 may generate a second SGCS based at least in part on feeding a second input or latent of a second UE model of the plurality of UE models to the global proxy model. The communication manager 906 may compare the first SGCS and the second SGCS. The communication manager 906 may switch from the first UE model to the second UE model based at least in part on the second SGCS being greater than the first SGCS. The communication manager 906 may switch from the first UE model to the second UE model based at least in part on the first SGCS being lower than an SGCS threshold and based at least in part on the second SGCS being greater than the first SGCS.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive information associated with a proxy model to be used for monitoring a performance of channel state information feedback. The transmission component 1004 may transmit, to a UE, configuration information that indicates for the UE to monitor the performance of the channel state information feedback. The reception component 1002 may selectively receive, from the UE, a report associated with the UE monitoring the performance of the channel state information feedback. The transmission component 1004 may transmit, to the UE, information to assist the UE with developing the proxy model.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE) or a UE training entity, comprising: generating a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model; monitoring the UE model using the proxy model; and selectively transmitting, to a network node, a report associated with monitoring the UE model using the proxy model.

Aspect 2: The method of Aspect 1, wherein the proxy model is to be used for monitoring a single model that corresponds to the UE model.

Aspect 3: The method of Aspect 2, wherein generating the proxy model comprises generating the proxy model based at least in part on a UE decoder that is configured to mimic the network model, wherein the UE decoder is a private decoder or a reference decoder.

Aspect 4: The method of Aspect 3, further comprising: generating the UE decoder, wherein the UE decoder is further configured to output the reconstructed channel state information; and calculating a squared generalized cosine similarity between target channel state information and the reconstructed channel state information for each sample in a training set associated with the proxy model, wherein generating the proxy model comprises generating the proxy model based at least in part on the squared generalized cosine similarity.

Aspect 5: The method of Aspect 4, wherein the proxy model is associated with UE-first sequential training, and wherein the UE model and the UE decoder are generated using data that is collected by a downlink measurement.

Aspect 6: The method of Aspect 4, wherein the proxy model is associated with network-first sequential training, and wherein the method further comprises: receiving an input of a reference encoder associated with the network model and an output of the reference encoder associated with the network model; and generating the UE model based at least in part on an input that corresponds to the input of the reference encoder and an output that corresponds to an estimate of the output of the reference encoder, wherein the UE decoder is configured to receive the output of the UE model as an input and to generate an output that is based at least in part on the input of the reference encoder or a target downlink precoder associated with a downlink measurement in a data collection.

Aspect 7: The method of any of Aspects 1-6, wherein the proxy model is to be used for monitoring a plurality of models that includes the UE model and the network model.

Aspect 8: The method of Aspect 7, wherein generating the proxy model comprises generating the proxy model based at least in part on the reconstructed channel state information.

Aspect 9: The method of Aspect 8, further comprising calculating a squared generalized cosine similarity, for each training sample associated with the proxy model, based at least in part on comparing the reconstructed channel state information with target or ground-truth channel state information.

Aspect 10: The method of Aspect 8, wherein the proxy model is associated with UE-first sequential training, and wherein the method further comprises: training the UE model using an input that corresponds to an input of an encoder and an output that corresponds to an output of the encoder, and a decoder having an input that corresponds to an output of the encoder and an output that corresponds to a UE estimation of channel state information; providing the output of the encoder and the UE estimation of channel state information to the network node; and receiving the reconstructed channel state information from the network node.

Aspect 11: The method of Aspect 8, wherein the proxy model is associated with network-first sequential training, and wherein the method further comprises: receiving, from the network node, an input of a reference encoder, an output of a reference encoder, and the reconstructed channel state information; and generating the UE model based at least in part on the input of the reference encoder and the output of the reference encoder.

Aspect 12: The method of Aspect 7, wherein generating the proxy model comprises generating the proxy model based at least in part on a key performance indicator associated with the network model.

Aspect 13: The method of Aspect 12, further comprising obtaining a squared generalized cosine similarity based at least in part on an output of the network model or based at least in part on an input of a reference encoder, an output of a reference encoder, and the reconstructed channel state information.

Aspect 14: The method of Aspect 7, wherein generating the proxy model comprises generating the proxy model based at least in part on decoder information.

Aspect 15: The method of Aspect 7, further comprising updating an output of the network model, a key performance indicator of the network model, or decoder information based at least in part on an interval or based at least in part on an update associated with the network model.

Aspect 16: The method of any of Aspects 1-15, wherein selectively transmitting the report to the network node comprises transmitting the report to the network node based at least in part on one or more squared generalized cosine similarity (SGCS) values not satisfying an SGCS threshold.

Aspect 17: The method of Aspect 16, wherein the report indicates one or more measurement instances associated with the one or more SGCS values not satisfying the SGCS threshold.

Aspect 18: The method of Aspect 16, wherein transmitting the report to the network node based at least in part on the one or more SGCS values not satisfying the SGCS threshold comprises transmitting the report to the network node based at least in part on an average SGCS value not satisfying an average SGCS threshold within a monitoring window.

Aspect 19: The method of Aspect 16, wherein transmitting the report to the network node based at least in part on the one or more SGCS values not satisfying the SGCS threshold comprises transmitting the report to the network node based at least in part on a number of SGCS values that do not satisfy the SGCS threshold within a monitoring window satisfying another threshold.

Aspect 20: The method of Aspect 16, further comprising refraining from transmitting another report to the network node until an expiration of a timer.

Aspect 21: The method of any of Aspects 1-20, wherein generating the proxy model comprises generating a plurality of proxy models associated with a respective plurality of UE models.

Aspect 22: The method of Aspect 21, further comprising: generating a first squared generalized cosine similarity (SGCS) based at least in part on feeding a first input or latent of a first UE model of the plurality of UE models to a corresponding first proxy model of the plurality of proxy models; generating a second SGCS based at least in part on feeding a second input or latent of a second UE model of the plurality of UE models to a corresponding second proxy model of the plurality of proxy models; and comparing the first SGCS and the second SGCS.

Aspect 23: The method of Aspect 22, further comprising switching from the first UE model to the second UE model based at least in part on the second SGCS being greater than the first SGCS.

Aspect 24: The method of Aspect 22, further comprising switching from the first UE model to the second UE model based at least in part on the first SGCS being lower than an SGCS threshold and based at least in part on the second SGCS being greater than the first SGCS.

Aspect 25: The method of any of Aspects 1-24, wherein generating the proxy model comprises generating a global proxy model across all UE models of a plurality of UE models associated with a network model identifier.

Aspect 26: The method of Aspect 25, further comprising: generating a first squared generalized cosine similarity (SGCS) based at least in part on feeding a first input or latent of a first UE model of the plurality of UE models to the global proxy model; generating a second SGCS based at least in part on feeding a second input or latent of a second UE model of the plurality of UE models to the global proxy model; and comparing the first SGCS and the second SGCS.

Aspect 27: The method of Aspect 26, further comprising switching from the first UE model to the second UE model based at least in part on the second SGCS being greater than the first SGCS.

Aspect 28: The method of Aspect 26, further comprising switching from the first UE model to the second UE model based at least in part on the first SGCS being lower than an SGCS threshold and based at least in part on the second SGCS being greater than the first SGCS.

Aspect 29: A method of wireless communication performed by a network node or a network training entity, comprising: receiving information associated with a proxy model to be used for monitoring a performance of channel state information feedback; transmitting, to a user equipment (UE), configuration information that indicates for the UE to monitor the performance of the channel state information feedback; and selectively receiving, from the UE, a report associated with the UE monitoring the performance of the channel state information feedback.

Aspect 30: The method of Aspect 29, wherein the configuration information indicates for the UE to monitor the performance of the channel state information feedback based at least in part on monitoring a UE model or based at least in part on monitoring a UE model and a network model.

Aspect 31: The method of any of Aspects 29-30, further comprising transmitting, to the UE, information to assist the UE with developing the proxy model.

Aspect 32: The method of any of Aspects 31, wherein the information to assist the UE with developing the proxy model includes reconstructed channel state information, a squared generalized cosine similarity value, or decoder information.

Aspect 33: The method of any of Aspects 29-32, wherein the configuration information includes an indication of a pairing identifier associated with a two-sided channel state information feedback model to be monitored by the UE, or includes an explicit indication of proxy monitoring information.

Aspect 36: An apparatus for wireless communication at a device, comprising a processor; memory coupled with the processor; and instructions stored in the memory and executable by the processor to cause the apparatus to perform the method of one or more of Aspects 1-33.

Aspect 37: A device for wireless communication, comprising a memory and one or more processors coupled to the memory, the one or more processors configured to perform the method of one or more of Aspects 1-33.

Aspect 38: An apparatus for wireless communication, comprising at least one means for performing the method of one or more of Aspects 1-33.

Aspect 39: A non-transitory computer-readable medium storing code for wireless communication, the code comprising instructions executable by a processor to perform the method of one or more of Aspects 1-33.

Aspect 40: A non-transitory computer-readable medium storing a set of instructions for wireless communication, the set of instructions comprising one or more instructions that, when executed by one or more processors of a device, cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory and configured to cause the UE to:
generate a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model;
monitor the UE model using the proxy model; and
selectively transmit, to a network node, a report associated with monitoring the UE model using the proxy model.

2. The apparatus of claim 1, wherein the proxy model is to be used for monitoring a single model that corresponds to the UE model.

3. The apparatus of claim 2, wherein the one or more processors, to generate the proxy model, are further configured to cause the UE to generate the proxy model based at least in part on a UE decoder that is configured to mimic the network model, wherein the UE decoder is a private decoder or a reference decoder.

4. The apparatus of claim 3, wherein the one or more processors are further configured to cause the UE to:
generate the UE decoder, wherein the UE decoder is further configured to output the reconstructed channel state information; and
calculate a squared generalized cosine similarity between target channel state information and the reconstructed channel state information for each sample in a training set associated with the proxy model,
wherein the one or more processors, to generate the proxy model, are further configured to cause the UE to generate the proxy model based at least in part on the squared generalized cosine similarity.

5. The apparatus of claim 4, wherein the proxy model is associated with UE-first sequential training, and wherein the UE model and the UE decoder are generated using data that is collected by a downlink measurement.

6. The apparatus of claim 4, wherein the proxy model is associated with network-first sequential training, and wherein the one or more processors are further configured to cause the UE to:
receive an input of a reference encoder associated with the network model and an output of the reference encoder associated with the network model; and
generate the UE model based at least in part on an input that corresponds to the input of the reference encoder and an output that corresponds to an estimate of the output of the reference encoder,
wherein the one or more processors are further configured to cause the UE to receive the output of the UE model as an input and to generate an output that is based at least in part on the input of the reference encoder or a target downlink precoder associated with a downlink measurement in a data collection.

7. The apparatus of claim 1, wherein the proxy model is to be used for monitoring a plurality of models that includes the UE model and the network model.

8. The apparatus of claim 7, wherein the one or more processors, to generate the proxy model, are further configured to cause the UE to generate the proxy model based at least in part on the reconstructed channel state information.

9. The apparatus of claim 8, wherein the one or more processors are further configured to cause the UE to calculate a squared generalized cosine similarity, for each training sample associated with the proxy model, based at least in part on comparing the reconstructed channel state information with target or ground-truth channel state information.

10. The apparatus of claim 8, wherein the proxy model is associated with UE-first sequential training, and wherein the one or more processors are further configured to cause the UE to:
train the UE model using an input that corresponds to an input of an encoder and an output that corresponds to an output of the encoder, and a decoder having an input that corresponds to an output of the encoder and an output that corresponds to a UE estimation of channel state information;
provide the output of the encoder and the UE estimation of channel state information to the network node; and
receive the reconstructed channel state information from the network node.

11. The apparatus of claim 8, wherein the proxy model is associated with network-first sequential training, and wherein the one or more processors are further configured to cause the UE to:
receive, from the network node, an input of a reference encoder, an output of a reference encoder, and the reconstructed channel state information; and
generate the UE model based at least in part on the input of the reference encoder and the output of the reference encoder.

12. The apparatus of claim 7, wherein the one or more processors, to generate the proxy model, are further configured to cause the UE to generate the proxy model based at least in part on a key performance indicator associated with the network model, and wherein the one or more processors are further configured to cause the UE to obtain a squared generalized cosine similarity based at least in part on an output of the network model or based at least in part on an input of a reference encoder, an output of a reference encoder, and the reconstructed channel state information.

13. The apparatus of claim 7, wherein the one or more processors, to generate the proxy model, are further configured to cause the UE to generate the proxy model based at least in part on decoder information.

14. The apparatus of claim 1, wherein the one or more processors, to selectively transmit the report to the network node, are further configured to cause the UE to transmit the report to the network node based at least in part on one or more squared generalized cosine similarity (SGCS) values not satisfying an SGCS threshold.

15. The apparatus of claim 14, wherein the report indicates one or more measurement instances associated with the one or more SGCS values not satisfying the SGCS threshold.

16. The apparatus of claim 14, wherein the one or more processors, to transmit the report to the network node based at least in part on the one or more SGCS values not satisfying the SGCS threshold, are further configured to cause the UE to transmit the report to the network node based at least in part on an average SGCS value not satisfying an average SGCS threshold within a monitoring window.

17. The apparatus of claim 14, wherein the one or more processors, to transmit the report to the network node based at least in part on the one or more SGCS values not satisfying the SGCS threshold, are further configured to cause the UE to transmit the report to the network node based at least in part on a number of SGCS values that do not satisfy the SGCS threshold within a monitoring window satisfying another threshold.

18. The apparatus of claim 1, wherein the one or more processors, to generate the proxy model, are further configured to cause the UE to generate a plurality of proxy models associated with a respective plurality of UE models.

19-21. (canceled)

22. The apparatus of claim 1, wherein the one or more processors, to generate the proxy model, are further configured to cause the UE to generate a global proxy model across all UE models of a plurality of UE models associated with a network model identifier.

23-28. (canceled)

29. A method of wireless communication performed by a user equipment (UE), comprising:
generating a proxy model to be used for monitoring a UE model, the proxy model being configured to receive an input that corresponds to an input of the UE model, an intermediate result associated with the UE model, or an output of the UE model, and being configured to generate an output that corresponds to a system performance metric, an intermediate key performance indicator, or a prediction of reconstructed channel state information obtained by a network model;
monitoring the UE model using the proxy model; and
selectively transmitting, to a network node, a report associated with monitoring the UE model using the proxy model.

30. (canceled)
